(19) United States
(12) Patent Application Publication
(10) Pub. No.: US 2025/0140052 A1
(43) Pub. Date: May 1, 2025

(54) ARTICLE SUPPLY APPARATUS AND ARTICLE SUPPLY SYSTEM

(71) Applicant: BANDAI CO., LTD., Tokyo (JP)

(72) Inventors: Hiroki KOBAYASHI, Tokyo (JP); Hajime KONDO, Tokyo (JP)

(21) Appl. No.: 18/914,209

(22) Filed: Oct. 13, 2024

(30) Foreign Application Priority Data
Oct. 30, 2023 (JP) 2023-185724

(51) Int. Cl. G07F 17/00; G07F 1/02; G07F 5/10; G07F 9/00; G07F 9/02; G07F 11/54; G07F 11/62; G07F 17/32

(52) U.S. Cl. CPC G07F 17/0014; G07F 9/001; G07F 9/023; G07F 11/54; G07F 11/62; G07F 17/3225; G07F 17/3253; G07F 1/02; G07F 5/10

(57) ABSTRACT

An article supply apparatus comprises a main body, an accommodation unit, which is configured to be attached to the main body and to store a first article, a supply unit, which is configured to supply the first article stored in the accommodation unit, an acquisition unit, which is configured to acquire information related to at least one of second articles provided separately from the main body, wherein the supply unit is configured to supply the first article on a first condition that the information related to the at least one of the second articles is acquired by the acquisition unit.

### CROSS-REFERENCE TO RELATED APPLICATIONS

The disclosure of Japanese Patent Application No. 2023-185724 filed on Oct. 30, 2023 including specification, drawings and claims is incorporated herein by reference in its entirety.

### TECHNICAL FIELD

The present invention relates to an article supply apparatus and an article supply system.

### BACKGROUND

Conventionally, there have been digital stamp rally systems designed to collect additional information stored on IC media. For example, in Japanese Patent Application Publication No. 2006-35434, signboards are placed at predetermined multiple locations and each of them is equipped with a non-contact IC medium. The non-contact IC medium stores additional information including first location information about the signboard, quiz information and answer information therefor, and second location information about another signboard to be visited or next quiz to be answered thereat. By bringing a non-contact IC medium close to an electronic device equipped with a reader/writer unit that reads the additional information stored in the non-contact IC medium through an antenna, the non-contact IC medium transmits the stored additional information. The electronic device receives and stores the transmitted additional information. The electronic device then audibly and/or visually displays at least the quiz information and the second location information contained in the additional information, and directs the game participant to visit the locations in sequence and answer the problems.

### SUMMARY

### Technical Problem

Japanese Patent Application Laid-Open No. 2006-35434 discloses a digital stamp collection system in which information such as quiz etc. is displayed on a signboard in digital data format, allowing participants to view their results through the internet. However, in this case, the system does not use a device that supplies goods, nor does it enhance the interest of participants (users).

It is an object of the present invention to provide an article supply apparatus and an article supply system which can increase user's interests.

### Solution to Problem

One aspect of the present invention is an article supply apparatus. The article supply apparatus comprises a main body, an accommodation unit which can be attached to the main body and can store first articles, a supply unit capable of supplying a first article stored in the accommodation unit, and an acquisition unit, which can acquire information related to at least one of second articles, and which is separately provided from the main body. The supply unit can supply the first article on condition that the information has been acquired by the acquisition unit.

Another aspect of the present invention is an article supply system. The article supply system comprises an article supply apparatus which is configured to supply a first article, a second article located at a first location, another second article located at another location different from the first location, and a user terminal. The article supply apparatus includes a main body, an accommodation unit attachable to the main body and can store articles, a supply unit capable of supplying the first article stored in the accommodation unit, and an acquisition unit capable of obtaining information relating to the second article. The user terminal can acquire information based on at least the first information related to the second article installed at the first location and other information related to the second article installed at another location. The supply unit can supply the first article on condition that the acquisition unit acquires the information from the user terminal.

### Advantageous Effect of Invention

According to the present invention, it is possible to provide an article supply apparatus and an article supply system which is configured to increase user's interest.

### BRIEF DESCRIPTION OF DRAWINGS

FIG. 1 is a schematic diagram of an article supply system according to an embodiment of the present invention;

FIG. 2 is a perspective view thereof, showing an example of the article supply apparatus in the article supply system;

FIG. 3 is a cross-sectional view of the article supply apparatus shown in FIG. 2;

FIG. 4 is a flowchart a supply flow of the first article in the article supply system; and

FIG. 5 is a front view showing an example of the article supply apparatus when two or more types of first articles are available.

### DETAILED DESCRIPTION

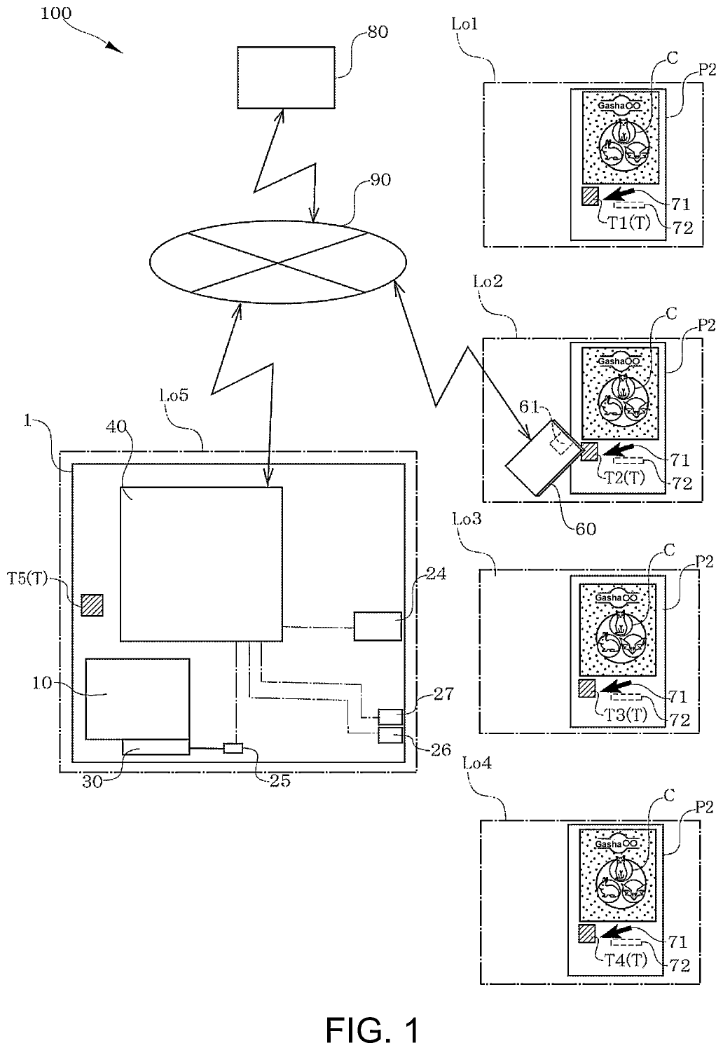

An article supply apparatus 1 according to an embodiment of the present invention will be described below with reference to the drawings. FIG. 1 is a schematic diagram of an article supply system 100 according to an embodiment of the present invention.

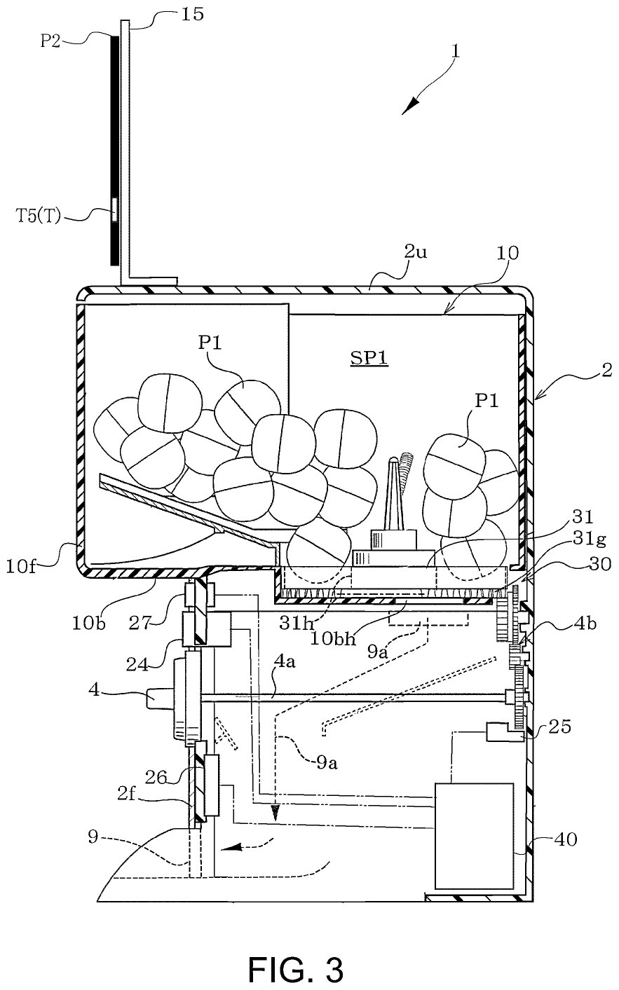

The article supply system 100 shown in FIG. 1 includes an article supply apparatus 1 capable of supplying a first article P1 (see FIG. 3), second articles P2 such as posters, which are respectively placed at first to fifth locations (Lo1, Lo2, Lo3, Lo4, Lo5), a user terminal 60, a server 80 containing specific data, and a communication network 90 such as the internet for connecting the server 80, the article supply apparatus 1, and the user terminal 60 to one another. Specifically, this article supply system 100 is used as, for example, a system for events where participants can acquire a first article P1, such as character goods, without needing to pay consideration thereof.

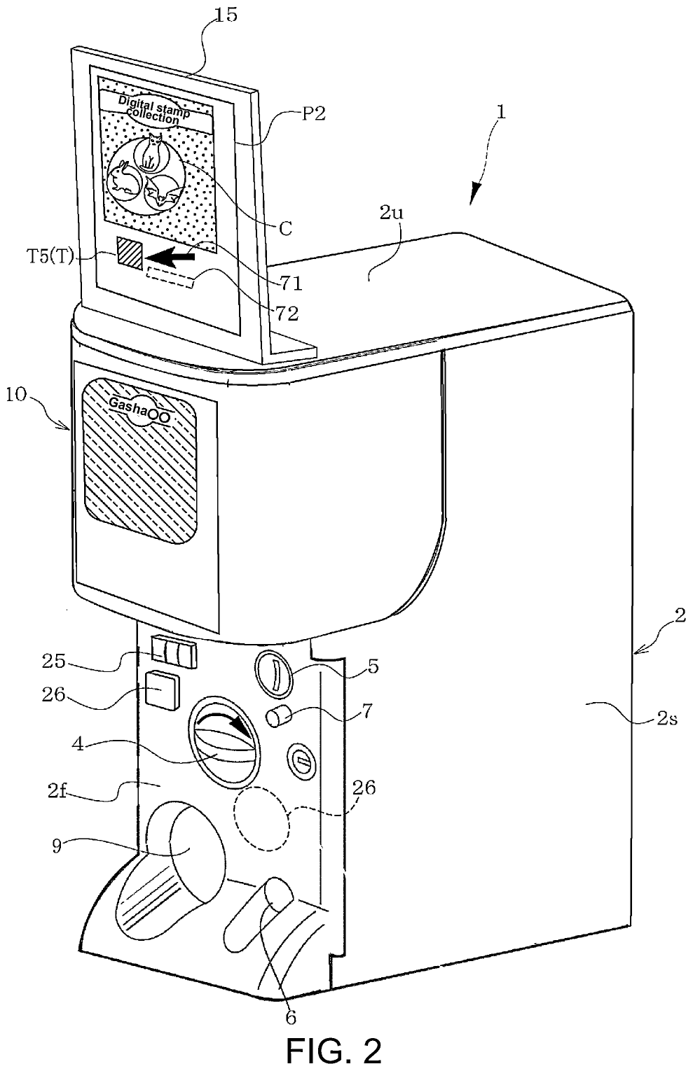

The second article P2 is, for example, a poster made of soft material (such as paper or a film sheet) containing specific character information. The first to fifth locations (Lo1, Lo2, Lo3, Lo4, Lo5) are geographically separate places from one another. For instance, these locations could be five different train stations along a railway line. Only the second article P2 is placed at the first to fourth locations (Lo1, Lo2, Lo3, Lo4). That is, no article supply apparatus is provided at these locations. Therefore, they are places where posters are displayed, such as on walls or billboards. The content of the second article P2, which is displayed thereon, is either identical or similar across locations. However, at the fifth location Lo5, while the second article P2 is the same in content, a way of installation is different. That is, as described later, the article supply apparatus 1 is provided thereat (see FIG. 2).

The user terminal 60 is capable of internet communication and is equipped with an image capture function and a contactless communication function (for example, NFC: near field communication). Each second article P2 (poster) is equipped with an NFC tag T (T1, T2, T3, T4, T5), which contains different information (hereafter referred to as “stamp information”) for each location. The user terminal 60 can acquire unique stamp information from the second article P2 at each location. For instance, a scanning unit 61 of an NFC reader provided in the user terminal 60 is used as an acquisition unit, to acquire stamp information by bringing it close to a tag T.

The stamp information includes not only stamp information for each location but also information of date and time when the stamp information is obtained (date and time information).

The information written on the tag T of the second article P2 cannot be viewed from the outside. For example, the tag T is attached to the second article P2, and the surface of the tag is covered with an attachment member so as not to be visible. The location of the tag T is indicated by an arrow 71 or a description 72 written close to the arrow 71. Thus, by using the user terminal 60 to scan the indicated area, the user can obtain the stamp information for the second article P2 located thereat.

FIG. 2 is a perspective view of the article supply apparatus 1. FIG. 3 is a cross-sectional view of the article supply apparatus 1. As shown in FIGS. 2 and 3, the article supply apparatus 1 includes a main body 2, an accommodation unit 10 attachable to the main body 2 and capable of accommodating articles P1, a supply unit 30 capable of supplying the first articles P1 one by one, stored in the accommodation unit 10, a lock unit 25 that locks an operation of the supply unit 30, an operation unit 4 that unlocks the lock unit 25 under specific conditions and allows the supply unit 30 to operate, and a passage unit 9a that allows the first article P1 to roll or pass from the accommodation unit 10 to the supply port 9.

The supply unit 30 includes a rotating disc 31 provided rotatably at the bottom 10b of the accommodation unit 10. The rotating disc 31 has two or more holding holes 31h, each of which is capable of holding the first articles P1. The rotating disc 31 randomly selects one of the first articles P1 from the accommodation unit 10 through a through-hole 10bh formed in the bottom 10b by rotation thereof and dispenses it to the passage unit 9a from one of the holding holes 31h.

The first article P1 is, for example, a roughly spherical object made of synthetic resin, designed to roll easily and provided with appropriate rigidity. The first article P1, optionally covered in wrapping film, is supplied to the user from the article supply apparatus 1 without separation of the article or damage thereof during the supply process.

The article supply apparatus 1 is equipped with a control unit 40 capable of communicating with outside devices. The article supply apparatus 1 has a camera 24 capable of acquiring image information, a light-emitting unit 27, and a sound-generating unit 26 which function as a notification unit, all of which are installed on the front side 2f of the main body 2 and connected to the control unit 40. The control unit 40 is also connected to the lock unit 25 which locks the operation of the operation unit 4 and which can unlock the lock unit 25 when certain conditions are met.

The rotating disc 31 of the supply unit 30 has a rack gear 31g attached to a lower end of the rotating disc 31, and this rack gear 31g engages with a gear train 4b. A rotating shaft 4a of the operation unit 4 is provided to drive the gear train 4b. The lock unit 25 engages with the gear train 4b to stop the rotation of this gear train 4b.

In this embodiment, a holding plate 15, which has an L-shape when viewed from a side thereof, is provided on an upper end 2u of the main body 2. A poster, which is the second article P2, is placed on the front face of this holding plate 15. This poster is not indispensable and may be omitted.

The server 80 manages the stamp information of the second article P2 and information of date and time when the user terminal 60 acquires the stamp information. For example, the user terminal 60 acquires stamp information from four different locations, and the server 80 manages multiple pieces of stamp information and time and date information thereof, which is sent to the server 80 from the user terminal. The date and time information is information of date and time at which the stamp information is acquired. The server 80 stores, for each user terminal 60, the stamp information and the acquisition date and time information transmitted from each user terminal 60. When a predetermined number (at least one, preferably multiple) of pieces of the stamp information is stored, and the acquisition date and time for each of those stamps falls within a specified period, the server 80 sends a reward code to the user terminal 60, wherein the reward code allows for supply of the first article P1. In this way, the user terminal 60 turns into a state where the user can receive the supply of the first article P1 as a reward by using the reward code. The reward code is information generated based on the stamp information and acquisition date and time information acquired by the user terminal 60 at each location and constitutes information regarding multiple second articles P2 installed at different locations.

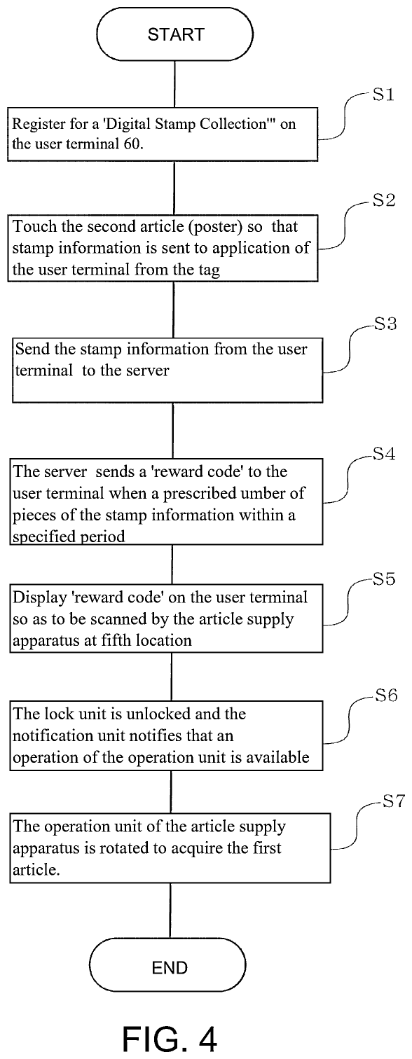

FIG. 4 is a flowchart showing an example of the supply flow for the first article P1 in the article supply system 100. An actual operation of the article supply system 100 and the flow of article supply will be explained below. First, when using the article supply system 100, for example, the user registers for a “Digital Stamp Collection” on the user terminal 60. At this time, a specified application therefor is installed on the user terminal 60 (Step 1).

Next, the NFC function of the user terminal 60 is turned on, and the scanning unit 61 is brought in contact with the tag T of the poster (the second article P2), thereby sending the stamp information from the tag T to the registered application (Step 2).

Next, the application on the user terminal 60 sends the stamp information and the corresponding acquisition date and time information to the server 80 (Step 3).

The server 80 manages the stamp information and acquisition date and time information, and if the predetermined number of pieces of the stamp information has been collected within the specified period, the server 80 sends a reward code (for example, a QR code) which allows the supply of the first article P1 to the user terminal 60 (Step 4).

Next, the user displays the reward code sent to the user terminal 60 on the application's screen thereof, and presents the reward code to the camera 24 of the article supply apparatus 1 so that the image of the reward code can be scanned (Step 5).

When the control unit 40 reads the reward code, the lock unit 25 is unlocked, and the notification unit (the sound generating unit 26 and the light-emitting unit 27) is activated, so that the operation of the operation unit 4 becomes available (Step 6).

Next, the user rotates the operation unit 4. As a result, the supply unit 30 is rotated, and the first article P1 is supplied to the supply port 9 (Step 7).

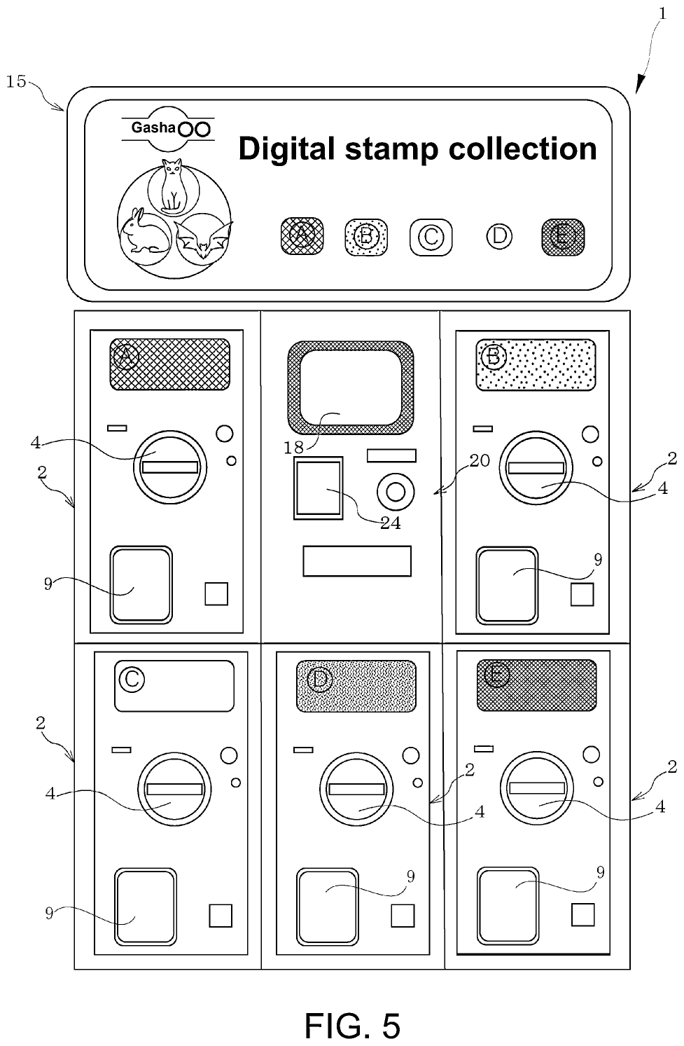

FIG. 5 is a front view illustrating an example of the article supply apparatus 1 when there are two or more types of first articles P1. When there are many types of first articles P1 that can be supplied, as shown in FIG. 5, the article supply apparatus 1 is configured to have two or more main bodies 2. In other words, there are two or more accommodation units 10, and each accommodation unit 10 can store different types of first articles P1, such as different characters. In the configuration shown in FIG. 5, five types (A, B, C, D, E) of the first artiles P1 are prepared. Additionally, in this case, for example, an operation panel 20 is provided, on which a camera 24 and a display screen, such as a liquid crystal touch panel 18, are provided.

The user selects one of the accommodation units 10 which stores the first article P1 the user want to receive, on the touch panel 18. At this time, the article supply apparatus 1 performs control so that only accommodation units 10 containing at least one first article P1 are selectable. Once the user selects one of the accommodation units 10 and present the reward code to the camera 24, the supply of the first article P1 from the selected accommodation unit 10 becomes available, allowing the user to obtain the desired first article P1. In the article supply apparatus 1 shown in FIG. 5, a display board 15 is prepared to indicate that the entire device is designed for a “digital stamp collection.” It should be noted that this article supply apparatus 1 is not equipped with a tag T and functions solely to supply article.

There may be cases where the server 80 shown in FIG. 1 is not used. In such cases, stamp information is stored within the application of the user terminal 60. When a predetermined number of stamps are collected within a specified period in the application, a reward code is displayed on the user terminal 60. This allows the user to follow the operations described in Steps 5 thereby obtaining the first article P1.

The article supply apparatus 1, as mentioned earlier, functions as part of the article supply system 100. However, the article supply apparatus 1 can also be configured to supply articles in exchange for payment independently of the function of the article supply system 100. In this case, the article supply apparatus 1 is equipped with a coin slot 5 for inserting consideration, a coin return slot 6, and a coin return button 7 (see FIG. 2). When the required coins are inserted, the lock 25 is released by the control unit 40, and the operation unit 4 becomes rotatable.

As described above, in this embodiment, the first article P1 is supplied from the main body 2 on condition that stamp information related to the second article P2, which is separate from the main body 2, is obtained by the acquisition unit (scanning unit 61). This necessitates the user to move between the main body 2 and the second article P2. In particular, when two or more second articles P2 are located in separate locations (Lo1, Lo2, Lo3, Lo4, Lo5), and the acquisition of stamp information of the two or more second articles P2 is required to obtain the first article P1, the user is encouraged to enjoy the activity of moving a certain distance.

In this embodiment, the posters (second articles P2), which are located in multiple locations (Lo1, Lo2, Lo3, Lo4, Lo5), are composed of the same or nearly identical types of articles, thereby making it easy for the user to recognize them and facilitating the acquisition of stamp information related to the second articles P2.

In this embodiment, when acquiring the necessary number of pieces of stamp information from the second articles P2, only one of two or more pieces of stamp information can be obtained at a time. This ensures that an acquisition time period and a moving distance are set as necessary conditions, thereby enjoying the movement between locations.

In this embodiment, the first article P1 can be acquired without requiring payment on condition that stamp information of the second articles P2 is acquired, so that acquisition is incentivized by using the first article P1 as a prize. This motivates the user to move between two or more locations (Lo1, Lo2, Lo3, Lo4, Lo5).

Furthermore, in this embodiment, the first article P1 can be supplied regardless of the chronological order between the first date and time information and the second date and time information when acquiring stamp information from the second articles P2. This allows the user to start collecting stamp information from any location (Lo1, Lo2, Lo3, Lo4, Lo5), making the activity of moving more enjoyable.

In this embodiment, stamp information related to the second articles P2 can be acquired through the user terminal 60, thereby making it easy for most users to participate. Additionally, since the acquisition of stamp information can be done contactlessly, the information can be acquired quickly and easily.

In this embodiment, since the stamp information of the second articles P2 is not visibly recognizable on the exterior, the enjoyment of acquiring stamp information is increased. The arrows 71 or instructions 72 are provided to indicate the position where stamp information can be obtained (the formation position), thereby making it easier to operate the user terminal 60.

In this embodiment, since the first articles P1 are made of a hard material and is capable of rolling, it can be easily supplied by the article supply apparatus 1. On the other hand, the second article P2, composed of a soft material such as a poster, can be placed in a wide range of locations without restrictions and character information can be easily displayed thereon.

In this embodiment, in an operation of the operation unit of the article supply apparatus 1 at least one of sound and light is emitted by the notification unit on condition that information related to the second article P2 has been obtained, so that a resplendent atmosphere can be created when the first article P1 is acquired.

In this embodiment, when two or more accommodation units 10 are provided in the main body 2, any one of the multiple accommodation units 10 can be selected by an operation, thereby allowing the user to obtain different characters according to his or her preference.

While the above-described embodiment of the present invention has been explained, the present invention can be appropriately modified within the scope of the technical ideas. For example, in the above embodiment, the system is configured with the article supply apparatus 1 installed at the fifth location Lo5, but this is not limited to this, and the article supply apparatus 1 can be installed at some of the locations or all the locations.

In the above embodiment, the reward code is scanned by the camera 24, but this is not limited to that. For example, a NFC for reading the reward code can be installed in the article supply apparatus 1, thereby allowing the reward code stored in the tag T of the user terminal 60 to be transmitted to the article supply apparatus 1 via contactless communication.

In the above embodiment, the second article P2 at the fifth location Lo5 is installed on a display board 15, but this is not limited to this and can be installed, for example, on the side 2s of the main body 2 or on the front face 10f of the accommodation unit 10.

The server 80 issues a reward code when two or more pieces of stamp information are collected within a specified period, but it may also be configured to issue a reward code upon receiving a single piece of stamp information from the user terminal 60.

As described above, the present specification discloses the following points:

(1) An article supply apparatus comprises a main body, an accommodation unit, which is can be attached to the main body and store a first article, a supply unit, which can supply the first article stored in the accommodation unit, an acquisition unit, which can obtain information related to at least one second article provided separately from the main body, wherein the supply unit can supply the first article on condition that the information related to the at least one second article is acquired by the acquisition unit.

(2) In the article supply apparatus according to (1), the information relates to two or more of the second articles.

(3) In the article supply apparatus according to (2), the information related to the two or more of the second articles includes at least first information possessed by one of the second articles installed at a first location, and another information, which is different from the first information and possessed by another second article which is installed at another location other than the first location.

(4) In the article supply apparatus according to (3), the one of the second articles installed at the first location and the another second article installed at the another location are the same as each other or similar to each other.

(5) In the article supply apparatus according to (3) or (4), the supply unit is configured to supply the first article on condition that the information including at least the first information and the another information is obtained within a specified period.

(6) In the article supply apparatus according to (5), the supply unit can supply the first article based on the condition without requiring a payment.

(7) In the article supply apparatus according to any one of (3) to (6), the information related to the two or more of the second articles includes first date and time information obtained when the first information is obtained from the one of the second articles by a user terminal, and second date and time information obtained when the another information is obtained from the another second article by the user terminal, and the supply unit is configured to supply the first article without considering a chronological order of the first date and time information and the second date and time information.

(8) In the article supply apparatus according to any one of (3) to (7), the acquisition unit cannot directly obtain the information related to the two or more of the second articles from the second articles.

(9) In the article supply apparatus according to (8), the acquisition unit can obtain the information related to the two or more of the second articles via the user terminal.

(10) In the article supply apparatus according to (9), the acquisition unit can acquire the information related to the two or more of the second articles from the user terminal without contact.

(11) In the article supply apparatus according to (9) or (10), the first information and the another information cannot be acquired simultaneously by the user terminal.

(12) In the article supply apparatus according to any one of (9) to (11), the first information and the another information is formed so as not to be visible on the second article.

(13) In the article supply apparatus according to any one of (9) to (12), positions where the first information and the another information are formed on the second articles are clearly indicated.

(14) In the article supply apparatus according to any one of (1) to (13), the first article is rollable, and the second article is unrollable.

(15) In the article supply apparatus according to any one of (1) to (14), the first article is made of a hard material, and the second articles are made of a soft material.

(16) In the article supply apparatus according to any one of (1) to (15), character information is provided on part of each of the second articles.

(17) The article supply apparatus according to any one of (1) to (16), further comprising an operation unit, which can perform an operation to dispense the article from the supply unit, wherein the supply unit is configured to supply the first article on condition that the operation unit is operated.

(18) In the article supply apparatus according to any one of (1) to (17), the accommodation unit includes at least a first accommodation unit and a second accommodation unit, the main body is further provided with a selection unit configured to select either the first accommodation unit or the second accommodation unit, and the selection unit allows for a selection operation between the first accommodation unit and the second accommodation unit on condition that both accommodation units can supply articles.

(19) In the article supply apparatus according to any one of (1) to (18), the main body is further provided with a notification unit which notifies acquisition of the information related to the second article, and the notification unit produces at least one of sound and light on condition that the information related to the second article is acquired.

(20) An article dispensing system, comprises an article supply apparatus can supply a first article, a second article installed at a first location, another second article installed at a location different from the first location, and a user terminal, wherein the article supply apparatus includes a main body, an accommodation unit which can be attached to the main body and store articles, a supply unit configured to supply the first article stored in the accommodation unit, and an acquisition unit can acquire information related to the second articles, the user terminal can acquire information based on at least the first information related to the second article installed at the first location and another information related to the second article installed at the other location, and the supply unit can supply the first article on condition that the acquisition unit acquires the information from the user terminal.

1. An article supply apparatus comprising:
a main body;
an accommodation unit, which is configured to be attached to the main body and to store a first article;
a supply unit, which is configured to supply the first article stored in the accommodation unit; and
an acquisition unit, which is configured to acquire information related to at least one of second articles provided separately from the main body;
wherein the supply unit is configured to supply the first article on a condition that the information related to the at least one of the second articles is acquired by the acquisition unit.

2. The article supply apparatus according to claim 1, wherein the information relates to two or more of the second articles.

3. The article supply apparatus according to claim 2, wherein the information related to the two or more of the second articles is based on at least first information possessed by one of the second articles installed at a first location and another information, which is different from the first information and possessed by another one of the second articles installed at another location other than the first location.

4. The article supply apparatus according to claim 3, wherein one of the second articles installed at the first location and the another one of the second articles installed at the another location are the same as or similar to each other.

5. The article supply apparatus according to claim 4, wherein the supply unit is configured to supply the first article on a second condition that the information based on at least the first information and the another information is obtained within a specified period.

6. The article supply apparatus according to claim 5, wherein the supply unit is configured to supply the first article based on the second condition without requiring a payment.

7. The article supply apparatus according to claim 6, wherein the information related to the two or more of the second articles includes first date and time information obtained when the first information is obtained from one of the second articles by a user terminal, and second date and time information obtained when the another information is obtained from the another one of the second articles by the user terminal, and the supply unit is configured to supply the first article without taking into consideration a chronological order of the first date and time information and the second date and time information.

8. The article supply apparatus according to claim 3, wherein the acquisition unit is configured so as to be unable to directly obtain the information related to the two or more of the second articles from the two or more of the second articles.

9. The article supply apparatus according to claim 8, wherein the acquisition unit is configured to obtain the information related to the two or more of the second articles via the user terminal.

10. The article supply apparatus according to claim 9, wherein the acquisition unit is configured to acquire the information related to the two or more of the second articles from the user terminal without contact.

11. The article supply apparatus according to claim 10, wherein the first information and the another information is configured so as not to be acquired simultaneously by the user terminal.

12. The article supply apparatus according to claim 11, wherein the first information and the another information is formed so as not to be visible on the second articles.

13. The article supply apparatus according to claim 12, wherein positions where the first information and the another information are formed on the second articles are specified.

14. The article supply apparatus according to claim 13, wherein the first article is configured to be rollable, and the second articles are configured so as not to be rollable.

15. The article supply apparatus according to claim 14, wherein the first article is made of a hard material, and the second articles are made of a soft material.

16. The article supply apparatus according to claim 15, wherein character information is provided on part of each of the second articles.

17. The article supply apparatus according to claim 1, further comprising an operation unit which can perform an operation to supply the first article from the supply unit, wherein the supply unit can supply the first article on condition that the operation unit is operated.

18. The article supply apparatus according to claim 1, wherein the accommodation unit includes at least a first accommodation unit and a second accommodation unit, the main body is further provided with a selection unit configured to select either the first accommodation unit or the second accommodation unit, and the selection unit allows for a selection operation between the first accommodation unit and the second accommodation unit on condition that both the first and second accommodation units are ready to supply the first article.

19. The article supply apparatus according to claim 1, wherein the main body is further provided with a notification unit which notifies acquisition of the information related to the one of the second articles, and the notification unit produces at least one of sound and light on condition that the information related to at least one of the second articles is acquired.

20. An article dispensing system, comprising:
an article supply apparatus configured to supply a first article;
a second article installed at a first location;
another second article installed at a location different from the first location; and
a user terminal,
wherein the article supply apparatus includes
a main body,
an accommodation unit which is configured to be attached to the main body and store a first article,
a supply unit configured to supply the first article stored in the accommodation unit, and
an acquisition unit configured to acquire information related to the second article,
wherein the user terminal is configured to acquire information based on at least first information related to one of the second articles installed at a first location and another information related to another one of the second articles installed at another other location, and
the supply unit is configured to supply the first article on condition that the acquisition unit acquires the information from the user terminal.
